(19) United States
(12) Patent Application Publication
(10) Pub. No.: US 2019/0242861 A1
(43) Pub. Date: Aug. 8, 2019

(54) PATTERNED CHEMICAL INDICATOR

(71) Applicant: 3M INNOVATIVE PROPERTIES COMPANY, St. Paul, MN (US)

(72) Inventors: Lisa Croll, St. Paul, MN (US); Duane D. Fansler, Dresser, WI (US); Hae-Seung Lee, Woodbury, MN (US); John Christopher Thomas, St. Paul, MN (US)

(21) Appl. No.: 16/270,410

(22) Filed: Feb. 7, 2019

Related U.S. Application Data
(60) Provisional application No. 62/627,985, filed on Feb. 8, 2018.

(51) Int. Cl. G01N 31/22; A62B 18/08; A62B 19/00; C09J 7/26; C09J 7/38; C09J 7/35

(52) U.S. Cl. CPC G01N 31/223; A62B 18/088; A62B 19/00; B01D 35/143; C09J 7/381; C09J 7/35; C09J 7/26

(57) ABSTRACT

A patterned chemical indicator with at least one indicating zone and at least one reference zone. The reference zone has a first and second major surfaces that are occluded surfaces; and, a reference area of the reference zone is circumferentially bounded by at least one non-porous dam.

### BACKGROUND

It is often desired to monitor an atmosphere for one or more gaseous chemicals, e.g. acid gases or basic gases.

### SUMMARY

In broad summary, herein is disclosed a patterned chemical indicator with at least one indicating zone and at least one reference zone. The reference zone comprises an inert, porous substrate that comprises first and second major surfaces that are occluded surfaces. At least a reference area of the reference zone may be circumferentially bounded by at least one non-porous dam. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary patterned chemical indicator as disclosed herein.

FIG. 2 is a top view of the patterned chemical indicator of FIG. 1.

FIG. 3 is a top view of another exemplary patterned chemical indicator.

FIG. 4 is a perspective view of an exemplary patterned chemical indicator installed into a filter cartridge.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower“, “under”, “over”, “front”, “back”, “outward”, “inward”, “up” and “down”, and “first” and “second” may be used in this disclosure, it should be understood that those terms are used in their relative sense only unless otherwise noted.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). The term “substantially”, unless otherwise specifically defined, means to a high degree of approximation (e.g., within +/−10% for quantifiable properties). The term “essentially” means to a very high degree of approximation (e.g., within plus or minus 2% for quantifiable properties); it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter, particularly for the case of a parameter that is variable.

### DETAILED DESCRIPTION

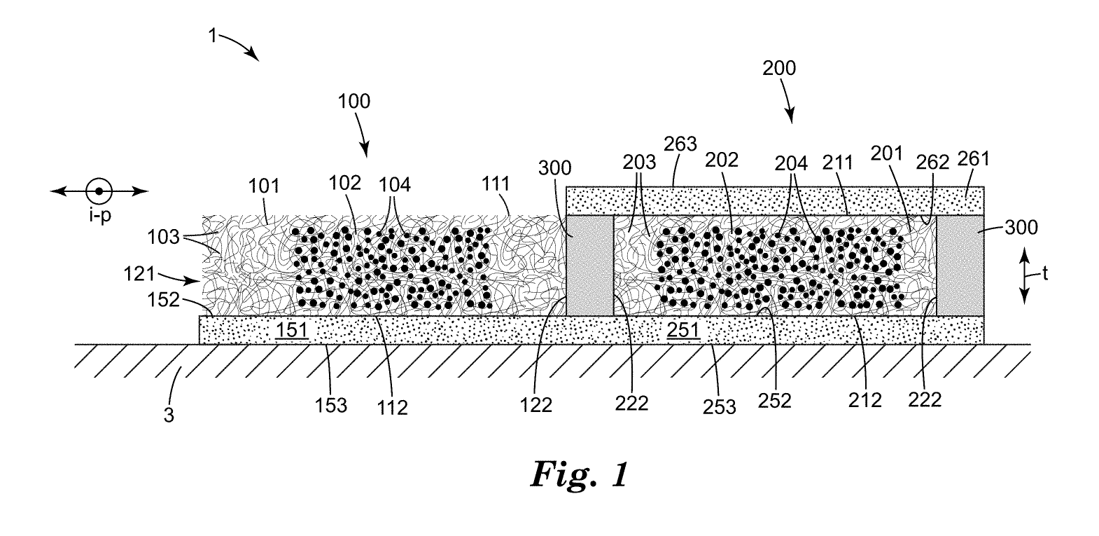

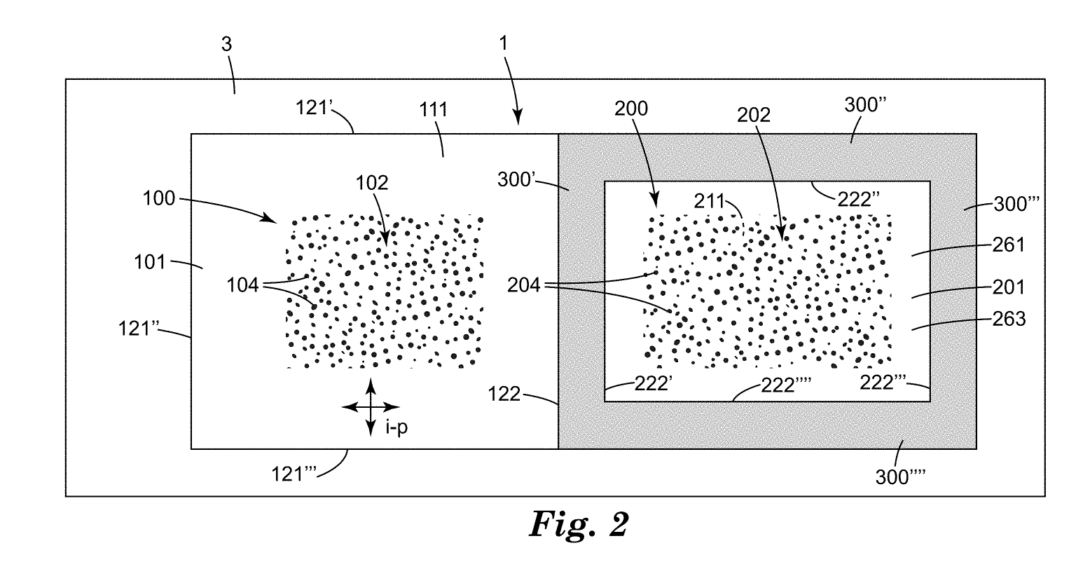

Disclosed herein is a patterned chemical indicator 1, as shown in side schematic cross-sectional view in FIG. 1 and in top view in FIG. 2. Indicator 1 comprises at least one indicating zone 100 comprising an inert, porous substrate 101. Substrate 101 is generally sheet-like or slab-like in appearance, with a shortest dimension (e.g., a thickness dimension “t” as indicated in FIG. 1) that is significantly shorter than the other, in-plane dimensions “i-p” (e.g., along the length or breadth of the substrate, also as indicated in FIG. 1) of the substrate. At least one indicator dye 104 is contained within at least some of the pores 103 of an indicating area 102 of the inert, porous substrate 101 of the indicating zone 100. In some embodiments, the inert, porous substrate 101 of indicating zone 100 comprises at least one major surface 111 that is a non-occluded surface. By non-occluded is meant that surface 111 is not covered or blocked by any occluding layer, i.e. a layer that could act as a barrier to prevent a gaseous chemical (discussed in detail later herein) from penetrating into substrate 101 through major surface 111. In some embodiments, major surface 111 may be an exposed surface, meaning that at least about 30% of the total area of surface 111 is not covered or obstructed by any such occluding layer. In various embodiments, at least about 40, 60, 80, 90, 95, or essentially 100% of the total area of surface 111 may be exposed. In some embodiments, surface 111 may be protected by a permeable material, e.g. a perforated or microperforated screen, a microporous membrane, a non-woven layer or scrim, a woven material, or the like, as long as such material is chosen to allow sufficient transport of gases therethrough. Any such permeable material, e.g. screen, may comprise a percent open area of e.g. at least about 20, 40, 60, or 80%; moreover, in some embodiments at least a portion of the area of any such permeable material may be disposed with a slight air gap between the permeable material and the major surface 111 of the porous substrate, to facilitate the transport of gases to the major surface of the substrate.

In addition to, or as an alternative to, the presence of an unoccluded major surface 111, the inert, porous substrate 101 of indicating zone 100 may comprise at least one minor edge that is an unoccluded minor edge 121. In some embodiments, such an unoccluded minor edge may be an exposed minor edge (e.g. as is edge 121 in the exemplary design of FIG. 1). In some embodiments, indicating zone 100 may comprise both an unoccluded (e.g. exposed) major surface 111 and an unoccluded (e.g. exposed) minor edge 121, as in the arrangement of FIG. 1. In the particular embodiment shown in top view in FIG. 2, indicating zone 100 comprises a generally rectangular shape such that exposed minor edge 121 of substrate 101 comprises three exposed minor edge segments 121′, 121″, and 121′ (noting that an indicating zone 100 can have any appropriate shape and is not limited to being e.g. rectangular.) It will be noted that in the exemplary design of FIGS. 1 and 2, indicating zone 100 does have one edge 122 that is an occluded minor edge, by virtue of the presence of a non-porous dam 300′ as indicated in FIG. 2 and as discussed in detail later herein.

It will be appreciated that an unoccluded major surface by definition will allow a gaseous chemical to penetrate into the interior of inert, porous substrate 101 in a direction at least generally along the thickness dimension (i.e., the shortest dimension) of substrate. An unoccluded minor edge by definition will allow a gaseous chemical to penetrate through that edge into the interior of inert, porous substrate 101 in a direction that is at least generally in-plane (e.g., along the length or breadth of the substrate). As noted, either arrangement, or both arrangements in combination, can be used as desired.

As noted, indicator dye 104 is present in an indicating area 102 of indicating zone 100. That is, indicating area 102 denotes the area within zone 100 in which dye 104 is actually present. In some embodiments, a portion of zone 100 may be free of dye (as in the exemplary embodiments of FIGS. 1 and 2). In other embodiments, the indicator dye 104 may be present at least substantially in the entirety of zone 100; that is, in such embodiments indicating area 102 may occupy the entirety of indicating zone 100. Upon a gaseous chemical penetrating into the interior of inert, porous substrate within indicating area 102, the gaseous chemical can contact indicator dye 104 thus causing the dye to e.g. change color, as discussed in detail later herein.

In many embodiments, indicating zone 100 (and, often, the entirety of inert, porous substrate 101 and e.g. the entirety of patterned chemical indicator 1) may be positioned on a carrier 3 (e.g. a suitably supportive film, slab, molded wall, or the like). In some convenient embodiments, inert, porous substrate 101 of indicating zone 100, may be secured to carrier 3 by an adhesive layer 151. In some embodiments, adhesive layer 151 may be a pressure-sensitive adhesive (e.g. a double-faced adhesive) 151, with a first major surface 152 that is adhesively bonded to major surface 112 of substrate 101, and with a second major surface 153 that is adhesively bonded to a major surface of carrier 3, as shown in exemplary manner in FIG. 1. In some embodiments, such an adhesive layer 151 may occlude major surface 112 of substrate 101 so that substantially no gaseous chemical is able to enter substrate 101 through this surface; however, in some embodiments at least some entry of gaseous chemical may occur through this surface.

Patterned chemical indicator 1 also comprises at least one reference zone 200. Reference zone comprises an inert, porous substrate 201. Substrate 201 is generally sheet-like or slab-like in similar manner as described above for substrate 101 of indicating zone 100. In some convenient embodiments, reference zone 200 and indicating zone 100 are separate zones of a common, single inert, porous substrate 101/201, as in the exemplary design shown in FIGS. 1 and 2. At least one indicator dye 204 is contained within at least some of the pores 203 of a reference area 202 of the inert, porous substrate 201 of the reference zone 200. That is, reference area 202 denotes the area of zone 200 in which dye 204 is actually present. In some embodiments, a portion of zone 200 may be free of dye (as in the exemplary embodiments of FIGS. 1 and 2). In other embodiments, the indicator dye 204 may be present at least substantially in the entirety of zone 200; that is, in such embodiments reference area 202 may occupy the entirety of reference zone 200. In some embodiments, indicator dye 204 of reference zone 200 will be of the same composition (e.g., it may be the exact same dye or combination of dyes) as indicator dye 104 of indicating zone 100.

Inert, porous substrate 201 of reference zone 200 comprises a first major surface 211 that is an occluded surface. By occluded is meant that surface 211 is covered in its entirety by an occluding layer 261 that acts as a barrier to prevent any gaseous chemical from penetrating into substrate 201 through major surface 211. In some embodiments, occluding layer 261 may be a layer or layers of gas-impermeable organic polymeric material. In particular embodiments, such an organic polymeric material may comprise a pressure-sensitive adhesive that comprises a first major surface 262 that is adhesively bonded to major surface 211 of inert, porous substrate 201. In some embodiments a second major surface 263 of such an adhesive layer may be exposed; in other embodiments a protective film may be adhesively bonded to surface 263. In some embodiments, such a protective film may provide additional gas-barrier properties above and beyond those of the adhesive layer itself. For example, such a film might be e.g. a semicrystalline organic polymeric film such as a polyolefin film or a polyester film. In some embodiments such a film may be oriented, e.g. biaxially oriented, and/or might be e.g. metallized, to further enhance its barrier properties.

Inert, porous substrate 201 of reference zone 200 comprises a second major surface 212 that is an occluded surface that is covered in its entirety by an occluding layer 251. In some embodiments major occluding layer 251 may be an impermeable organic polymeric material, e.g. a pressure-sensitive adhesive. In some convenient embodiments such a pressure-sensitive adhesive may be used not only for purposes of occlusion, but also to secure reference zone 200 to a carrier 3. In some embodiments, pressure-sensitive adhesive layer 251 that is used to secure reference zone 200 to carrier 3, and pressure-sensitive adhesive layer 151 that is used to secure indicating zone 100 to carrier 3, may be of the same composition. In fact, adhesives 151 and 251 may be different portions of a single piece of adhesive, as shown in exemplary embodiment in FIG. 1.

In brief summary, reference zone 200 comprises first and second major surfaces 211 and 212 that are both occluded so that gaseous chemicals are substantially unable to penetrate into inert, porous substrate 201 of reference zone 200, through these major surfaces.

In addition to the above-described occluded major surfaces, inert, porous substrate 201 of reference zone 200 also comprises at least one non-porous dam 300. By non-porous is mean that the material of dam 300 is substantially impermeable to gaseous chemicals. As discussed later in detail, this may be achieved e.g. by densifying the material of inert, porous substrate 201 to collapse the pores 203 thereof or, this may be achieved e.g. by filling the pores 203 with a non-porous (non-permeable) material. As evident from FIG. 2, in at least some embodiments non-porous dam 300 can be configured so that at least the reference area 202 of reference zone 200 is circumferentially bounded by non-porous dam 300. By circumferentially bounded is meant that reference area 202 is surrounded by non-porous dam 300 in all in-plane directions; use of this term is for convenience of description and does not limit dam 300 to a strictly, or even generally, circular geometry. In the exemplary design of FIG. 2, dam 300 is generally rectangular in shape, with dam 300 comprising four segments 300′, 300″, 300′″, and 300″″. Dam 300 can be any suitable shape, e.g. circular, oval, rectangular (which includes square), irregular and so on.

Non-porous dam 300 extends through the shortest dimension (i.e. the thickness) of inert, porous substrate 201 from the first major surface 211 to the other major surface 212 (noting that in some embodiments e.g. in which substrate 201 is densified to form dam 300, the thickness of substrate 201 in the actual location of dam 300 may be smaller than that of the undensified substrate in other locations). In many embodiments, an occluding layer 261 as described earlier herein, may extend sufficiently far in an in-plane direction of substrate 201 (e.g., along a length and/or width of the substrate) to overlap at least a portion of any such non-porous dam 300 as might be present. In the exemplary embodiment depicted in FIG. 1, occluding layer 261 overlaps the entirety of dam 300 at all locations of dam 300.

Non-porous dam 300, of a composition and configuration as disclosed herein, will act as a barrier to prevent permeation of gaseous chemicals, in a generally in-plane direction, into a portion of inert, porous substrate 201 that is desired to serve as a reference zone 200. In some embodiments, dam 300 will thus provide that minor edges 222 (e.g., edges 222′, 222″, 222′″, and 222″′ of FIG. 2) of inert, porous substrate 201 of reference zone 200 are occluded edges. In other words, such a dam 300 can prevent gaseous chemicals from entering a minor edge of substrate 201 of reference zone 200 to reach indicator dye 204 of reference zone 200.

It will be appreciated that occluding of both major surfaces of reference zone 200, in combination with occluding minor edges of reference zone 200, can more effectively isolate the indicator dye 204 of reference zone 200 so that the dye cannot be accessed by any gaseous chemical in any meaningful time frame during the use of the patterned chemical indicator. This renders zone 200 able to serve more effectively as a reference to which indicating zone 100 can be compared in order to ascertain whether indicating zone 100 has changed in color (or, in general, in appearance) thus indicating the presence of a gaseous chemical.

Numerous advantages accrue from providing a reference zone that first, comprises an actual gas-responsive dye (e.g., the same dye as used in the indicating zone); and second, that more effectively isolates the dye in an environment in which it cannot be reached by a gaseous chemical. For example, such a reference zone will echo the appearance of the indicating zone despite any changes in e.g. temperature, light level, wavelength, or character, and so on. This can provide that even subtle changes in the appearance of the active dye in the indicating zone due to the presence of a gaseous chemical, can be more easily discerned in comparison to the inactive dye in the reference zone. Such changes can thus be distinguished from e.g. changes that might result from temperature, light levels, atmospheric conditions, and so on. Such advantages may be particularly noticeable e.g. in embodiments in which the inert, porous substrate that is used is highly permeable to gases, and/or in which the gases are highly mobile entities such as e.g. acid gases or basic gases.

In some embodiments, indicating zone 100 and reference zone 200 may be different zones of a single, inert porous substrate 101/201, as in the exemplary embodiment of FIGS. 1 and 2. Such zones may be spaced apart from each other along an in-plane direction of the single, inert porous substrate. The indicating zone and the reference zone will be separated from each other by some portion of the at least one non-porous dam 300. Thus, in some embodiments a patterned chemical indicator as disclosed herein can comprise a single inert, porous substrate that comprises at least one indicating zone and at least one reference zone, the indicating zone(s) and the reference zone(s) being separated from each other by one or more non-porous dams, so that a gaseous chemical can access the indicator dye of the indicating zone but cannot access the indicator dye of the reference zone. If desired, the single inert, porous substrate can be secured to a substrate by a single piece of pressure-sensitive adhesive 151/251 as discussed earlier herein.

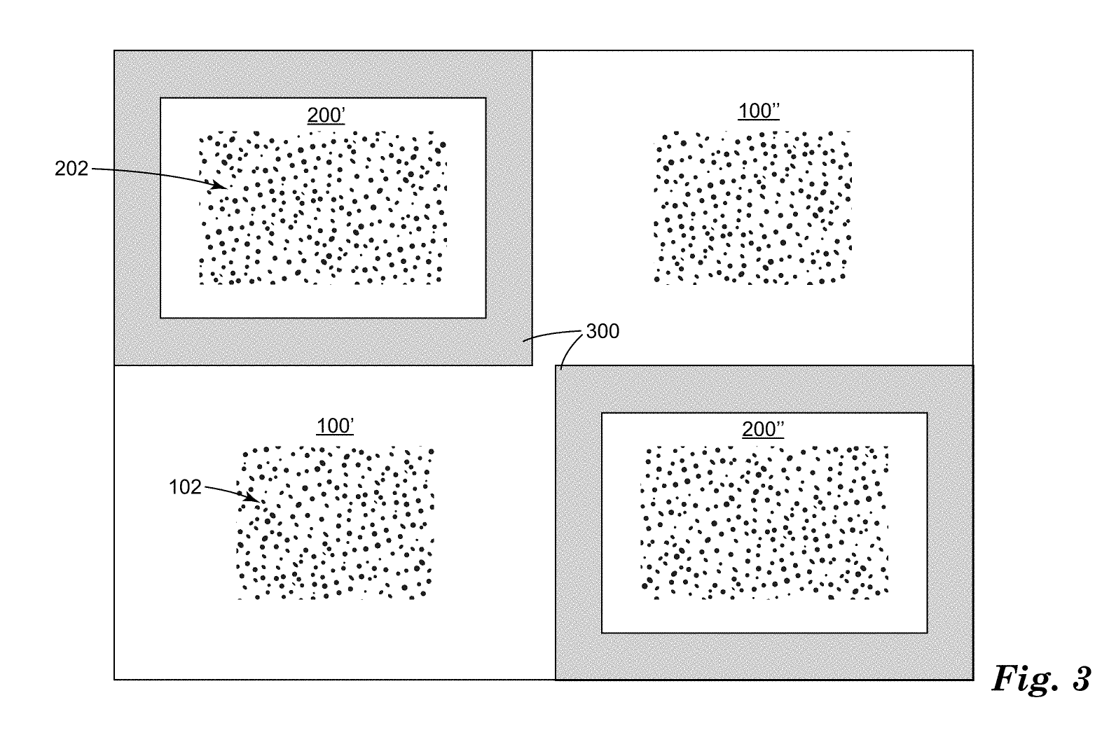

The arrangements shown in FIGS. 1 and 2 are examples of simple designs comprising a single indicating zone 100 and a single reference zone 200. However, any number of indicating zones and/or reference zones may be used. FIG. 3 depicts an arrangement in which two indicating zones (100′ and 100″) and two reference zones (200′ and 200″) are used. Each reference zone is circumferentially bounded by a non-porous dam (300′ and 300″). While in the exemplary design of FIG. 3, reference zones 200′ and 200″ are separately bounded by separate dams 300′ and 300″, in some embodiments a dam or a portion thereof may serve to bound more than one reference zone. It will be appreciated that any number of indicating zones and/or reference zones can be used, arranged in any pattern or array, regular or irregular, as desired.

Non-porous dam 300 can be provided in any suitable manner. In general, such manners may fall into two categories—treatment of the material of the inert, porous substrate 201 in some manner that removes (destroy) the pores thereof; and, filling the pores of substrate 201 with some material is impermeable and thus prevents any permeation of gaseous chemical through substrate 201.

In some embodiments, e.g. in embodiments in which substrate 201 is comprised of an organic polymeric material, such a material may be treated to remove the pores thereof. For example, if the organic polymeric material is thermoplastic, the material may be brought to a temperature that causes the material to soften and/or melt to an extent that the material densifies. The material itself may be chosen (e.g. it may be a semicrystalline material) to exhibit little or no inherent gas-permeability, so that the densified material can provide an excellent gas barrier. (Any few pores that remain may be isolated from each other and thus not contribute in any meaningful way to gas-permeability). Any such thermal treatment may be done in such manner to locally heat the inert, porous substrate 201 in regions in which densification is desired, while minimizing the heat exposure of other areas of the substrate. In some embodiments, contact heating, e.g. using a heated platen that is patterned according to the desired shape of the non-porous dam to be produced, can be used.

If the organic polymeric material of inert, porous substrate 201 is susceptible to attack by an organic solvent, such a solvent can be carefully contacted against a major surface of the substrate to cause pore collapse/densification in selected regions of the substrate. If desired, exposure to solvent can be combined with exposure to heat. Mechanical pressure may of course also be used as an adjunct to any such method. Any such method or combination thereof may be applied to any porous substrate comprised of a suitable organic polymeric material, e.g. a microporous membrane (such as e.g. a TIPS membrane as described later herein), a non-woven web or a woven fabric, and so on. As noted earlier herein, methods of providing a non-porous dam that rely on densification of the material of porous substrate 201 may, in some circumstances, cause the thickness of substrate 201 in the actual location of dam 300 to be smaller than that of the undensified substrate in other locations. Given this possibility, in some embodiments an occluding layer 261, in particular a pressure-sensitive layer, may be chosen to be sufficiently conformable to conform to any such local differential in the thickness of substrate 201.

In some embodiments, a non-porous dam may be provided by at least substantially filling the pores 203 of inert, porous substrate 201 with a filling material that will remain stably present in the pores and that is substantially impermeable to gaseous chemicals. Such methods will of course be most practicable for a substrate 201 that exhibits interconnected pores that will readily allow the filling material to enter the substrate (e.g. through a major surface thereof) and to flow through the pores so as to fill the pores throughout the entire thickness of the substrate. Such an approach may be applied to any suitable inert, porous substrate, whether it is e.g. a microporous membrane, a non-woven web, an open-cell foam, and so on. Any suitable filling material that can be introduced into pores 203 of substrate 201 may be used. In some embodiments, the filling material may be a flowable material, e.g. one that is heated to a temperature sufficient to lower its viscosity enough to permit the needed flow. Such a material might be e.g. a wax or a hot-melt adhesive that is applied in liquid form and that solidifies upon being cooled. However, in some embodiments it may not be strictly necessary that the filling material becomes a true solid after being incorporated into the pores of the substrate. For example, the filling material might be e.g. a flowable oil or grease, as long as the material exhibits sufficiently high gas-barrier properties. By way of particular example, a hydrocarbon grease or wax might be easily able to penetrate an organic polymeric microporous membrane and, having filled the pores thereof, might stably remain in the pores (e.g. without evaporating therefrom to any significant extent) and exhibit adequate barrier properties to the passage of e.g. an acid gas or basic gas.

A patterned chemical indicator as disclosed herein comprises an inert, porous substrate. By “porous” is meant a substrate that comprises a porosity of at least 20% and comprises an average pore diameter of less than 1000 micrometers. In various embodiments a porous substrate exhibits a porosity of at least 40, 60, 80, 90, or 95%. In some embodiments the porous substrate is a microporous substrate, e.g. a microporous film or membrane. In various embodiments, a microporous substrate exhibits an average pore diameter of from 1 to about 500 micrometers, or 1 to about 100 micrometers or even 1 to about 10 micrometers. In some embodiments the porous substrate may be a nanoporous substrate, e.g. which exhibits a pore diameter in the range of 100 nm or less. Any such porous substrate, e.g. microporous or nanoporous substrate, will exhibit an interconnected pore structure that enables gases to permeate into and through the interior of the substrate.

The porous substrate serves as a container that holds the indicator dye and that presents the indicator dye (of the indicating zone) in a condition in which it can be accessed by a gaseous chemical. Additionally, the porous substrate of the indicating zone acts as a diffusion layer, facilitating transport of the gaseous chemical to the indicator dye or dye mixture. In some embodiments, the inert porous substrate may be opaque. Many porous and microporous substrates are opaque, even if prepared from optically transparent materials, because the surfaces and internal structure of these substrates scatter visible light. In the present disclosure, this opacity may be advantageous as it can provide a background for monitoring changes in the indicator dye or dye mixture, such as, for example, color changes.

As noted herein, porous substrate 101 of indicating zone 100, and porous substrate 201 of reference zone 200, are inert. As used herein, the term “inert” when used to describe porous substrates or adhesive layers, means that the porous substrates or adhesive layers are substantially unaffected by reactive gases, and specifically are unreactive with acidic or basic gases. That is, an inert material will remain substantially physically and chemically unchanged when exposed to reactive gases, e.g. acidic or basic gases. Furthermore, an inert substrate will be substantially free of acidic or basic components that can be emitted from that material and/or that may be exposed at a surface e.g. of a pore of the material. An example of an inert substrate as disclosed herein would be e.g. a microporous membrane consisting of an organic polymeric hydrocarbon material; an example of a substrate that is not inert would be the same substrate having been imbibed with an acrylate coating that included e.g. 2% acrylic acid by weight.

A variety of materials can be used to prepare the inert, porous substrate. Either inorganic or organic materials may be used. In some embodiments, hydrocarbon-based polymeric materials are used. Polyolefinic materials, such as, for example, polyethylene, polypropylene, and the like and blends thereof, are a particularly useful class of materials for preparing the inert, porous substrate.

In some embodiments, the inert, porous substrate comprises a microporous membrane. Suitable microporous membranes for use as the inert, porous substrate include those resulting from a phase inversion method in which an initially homogeneous polymer solution is cast and exposed to a cooler interface (e.g., a water bath or chilled casting wheel), and phase separation is induced in the solution film by lowering the temperature (thermally induced phase separation or “TIPS”). Suitable TIPS films or membranes may possess a broad range of physical film properties and microscopic pore sizes. They may be relatively rigid or non-rigid substrates prepared from any of a variety of polymers. TIPS membranes made according to the teachings of U.S. Pat. Nos. 4,539,256 and 5,120,594 are suitable for use in this disclosure and may comprise high density polyethylene (HDPE), polypropylene, polyvinylidenefluoride (PVDF), polyethylene-vinyl alcohol copolymer (e.g., available under the trade designation EVAL F101A from EVAL Company of America (EVALCA), Houston, Tex.), for example. The membrane may comprise a combination of materials such as a TIPS HDPE or a polypropylene membrane coated with a hydrophilic polymer (e.g., polyethylene-vinyl alcohol copolymer or EVAL).

Other useful materials that may be suitable for use as the inert, porous substrate include: non-rigid polymers and other materials including nylon materials such as Nylon 6,6 materials (e.g., those available under the trade designation Biodyne B from Pall Corporation, Pensacola, Fla. and those available under the trade designation Magnaprobe from GE Osmonics Labstore in Minnetonka, Minn.); polypropylene membranes with a 0.45 micrometer pore size, available under the trade designation GHP-450 from Pall Corporation; polyester; nitrocellulose; cellulose acetate; hydrophilic polytetrafluoroethylene (PTFE); polycarbonate; and the like. Additional useful materials include nonwoven, melt blown, or spunbond webs made from, for example, polyolefins, nylon, polyvinylidene fluoride (PVDF), and the like, prepared with small effective fiber diameter. Also suitable are melt blown and spunbond webs that are compressed with pressure to reduce substrate thickness and pore size as described in U.S. Pat. No. 6,533,119. Additional substrate materials include, particle-filled microporous substrates are described in U.S. Pat. Nos. 6,264,864, 6,348,258, 4,777,073 and porous substrates prepared from nanosized electrospun fibers as described in US Patent Publication 2006/094320. Combinations of materials may be used in the inert, porous substrate and the foregoing description is to be understood to include the aforementioned materials alone and in combination with other materials.

The patterned chemical indicators of this disclosure comprise an indicator dye (which term broadly encompasses e.g. a single dye, or a mixture of two or more dyes, along with any other ingredients as may enhance the functioning of the dye(s), may stabilize the dye, and so on. A wide variety of materials may be used as the indicator dye. Upon exposure to an analyte, the indicator dye or dye mixture will undergo a detectable optical change. Broadly speaking, any optical change may be utilized, whether e.g. a change in visual appearance, the presence or absence of (or a change in the level of) fluorescence, a change in the amount or character of non-visible radiation (e.g. UV or IR, as detected by a suitable detector), and so on. Often the detectable change is a colorimetric change in visual appearance that is detectable with the naked eye and/or is readily interrogatable by a suitable optical sensor. Such a detectable change can take a variety of modes, such as, for example, from a colored state to a colorless or less colored state, from a colorless state to a colored state, or from one color to different color, e.g. from a less intensely colored state to a more intensely colored state. In some embodiments, the change will be an actual change in the observed color (e.g., from yellow to red, as with the exemplary dye Methyl Red when in the presence of an acid gas such as SO₂), rather than merely a change in the intensity of a given color.

Generally, the indicator dye or dye mixture is in a form such that a detectable change occurs upon exposure to the desired analyte. For example, if it is desired that the indicator dye detect the presence of an acid gas, the indicator dye typically is in a basic form. Similarly, if it is desired that the indicator dye detect the presence of a basic gas, the indicator dye typically is in an acidic form. Mixtures of dyes in acidic and basic form can be used if desired.

If the chemical indicator is designed to detect acid gases, an indicator dye or dye mixture is selected that upon exposure to acidic species undergoes a detectable change, such as for example, a color change. A wide range of such indicator dyes are available. Various forms of indicator dyes or dye mixtures may be useful, including, for example acidic or basic forms, and various salts that provide for improved solubility or reactivity characteristics. Suitable dyes may be located, for example, in “The Sigma-Aldrich Handbook of Stains, Dyes, and Indicators”, Floyd J. Green, 1990, The Sigma-Aldrich Chemical Company, Inc. Examples of suitable dyes for detecting acid gases include, for example, Bromothymol Blue, Methyl Red and Phenol Red, Bromocresol Purple, Bromocresol Green, Phenophthalein, and Congo Red when used in their basic forms. Of these, Bromothymol Blue, Methyl Red and Phenol Red, are particularly suitable.

If the chemical indicator is designed to detect basic gases, an indicator dye or dye mixture is selected that upon exposure to basic species undergoes a detectable change, such as, for example, a color change. A wide range of such indicator dyes are available. Examples of suitable dyes for detecting basic gases include, for example, the same indicators described above where the dyes are present in their acidic forms.

The dye may be accompanied by any suitable material or materials that may enhance the functioning of the dye. For example, an acid-base indicator dye (of any suitable type) may be accompanied by one or more acid-base buffers that may tailor the performance of the indicator dye to a suitable range of acidity or basicity and thus may optimize the dye for the detection of a particular gaseous chemical. Any suitable buffer or buffers, at any suitable concentration, may be used.

A wide variety of adhesives may be used as an occluding layer of the reference zone and/or to attach the indicating zone to a carrier. Typically the adhesive may be a pressure-sensitive adhesive. Pressure-sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure-sensitive adhesives are polymers designed and formulated to exhibit the requisite viscoelastic properties resulting in a desired balance of tack, peel adhesion, and shear holding power. In many embodiments, a pressure-sensitive adhesive may comprise one or more elastomeric components, e.g. in combination with one or more tackifying resins; however, some compositions may exhibit pressure-sensitive properties without necessarily including a tackifying resin.

Potentially useful pressure-sensitive adhesives include e.g. those based on natural rubbers, synthetic rubbers, styrene block copolymers, acrylics, poly-α-olefins, or silicones. Useful natural rubber pressure-sensitive adhesives generally contain masticated natural rubber, from 25 parts to 300 parts of one or more tackifying resins to 100 parts of natural rubber, and typically from 0.5 to 2.0 parts of one or more antioxidants. Another potentially useful class of pressure-sensitive adhesives are those comprising synthetic rubber. Such adhesives are generally rubbery elastomers, which are either self-tacky or non tacky and require tackifiers. Self-tacky synthetic rubber pressure-sensitive adhesives include for example, butyl rubber, a copolymer of isobutylene with less than 3 percent isoprene, polyisobutylene, a homopolymer of isoprene, polybutadiene, such as “TAKTENE 220 BAYER” or styrene/butadiene rubber. Some synthetic rubber pressure-sensitive adhesives incorporate tackifiers; for example, some such adhesives comprise polybutadiene or styrene/butadiene rubber, from 10 parts to 200 parts of a tackifier, and generally from 0.5 to 2.0 parts per 100 parts of an antioxidant. An example of a synthetic rubber is “AMERIPOL 1011A”, a styrene/butadiene rubber available from BF Goodrich.

Another potentially useful class of pressure-sensitive adhesives are those comprising styrene block copolymer elastomers, e.g. materials that comprise elastomers of the A-B or A-B-A type, where A represents a thermoplastic polystyrene block and B represents a rubbery block of polyisoprene, polybutadiene, or poly(ethylene/butylene), and resins. Examples of the various block copolymers useful in block copolymer pressure-sensitive adhesives include linear, radial, star and tapered styrene-isoprene block copolymers such as “KRATON D1107P”, available from Shell Chemical Co., and “EUROPRENE SOL TE 9110”, available from EniChem Elastomers Americas, Inc.; linear styrene-(ethylene-butylene) block copolymers such as “KRATON G1657”, available from Shell Chemical Co.; linear styrene-(ethylene-propylene) block copolymers such as “KRATON G1750X”, available from Shell Chemical Co.; and linear, radial, and star styrene-butadiene block copolymers such as “KRATON D1118X”, available from Shell Chemical Co., and “EUROPRENE SOL TE 6205”, available from EniChem Elastomers Americas, Inc.

Another potentially useful class of pressure-sensitive adhesives are poly-α-olefin pressure-sensitive adhesives, also called poly(l-alkene) pressure-sensitive adhesives, generally comprise either a substantially uncrosslinked polymer or a uncrosslinked polymer that may have radiation activatable functional groups grafted thereon as described, for example, in U.S. Pat. No. 5,209,971. The poly-α-olefin polymer may be self tacky and/or include one or more tackifying materials. Useful poly-α-olefin polymers include, for example, C₃-C₁₈ poly(l-alkene) polymers, preferably C₅-C₁₂ α-olefins and copolymers of those with C₃ and more preferably C₆-C₈ and copolymers of those with C₃.

Another potentially useful class of pressure-sensitive adhesives are the well-known acrylic (acrylate) pressure-sensitive adhesives. Such adhesives may comprise any of many well-known (meth)acrylate monomer units, such as e.g. isooctyl acrylate, butyl acrylate, 2-ethylhexyl acrylate, isobutyl acrylate, isobornyl acrylate, and so on. In particular embodiments, such an acrylic pressure-sensitive adhesive will comprise less than 0.1% by weight of monomer units (or any other components such as e.g. side-chain units, tackifiers or other additives, etc.) that are acidic or basic or that are hydrolyzable (e.g. under ambient, room-temperature conditions) to form acid or basic units, for the reasons that were discussed previously herein. A well known example of an acid monomer unit that would be subject such a constraint would be acrylic acid.

Still another potentially useful class of pressure-sensitive adhesives are silicone pressure-sensitive adhesives; such adhesives may be formed e.g. from mixtures of compounds in which are present vinylic groups and hydrosilane groups. Vinylic groups comprise terminal carbon-carbon double bonds and hydrosilane groups comprise at least one terminal Si—H bond. Typically, elastomeric silicone-containing polymers are formed through the hydrosilylation reaction. Tackifying agents such as so-called “MQ” resins are often combined with silicone elastomers to form silicone pressure-sensitive adhesives.

In particular embodiments, a pressure-sensitive adhesive as used herein may comprise polyisobutylene (PIB), e.g. as an elastomeric component of the adhesive. Such materials, being prepared from isobutylene monomer, may exhibit high purity since any residual monomers remaining after polymerization will be so gases that readily leave the polymer. Furthermore, polyisobutylene and polyisobutylene-containing materials often exhibit advantageously low permeability to gases, which may render such materials particularly useful as an occluding layer of the reference zone.

Polyisobutylene materials are commercially available from several manufacturers. Homopolymers are commercially available, for example, under the trade designation OPPANOL (e.g., OPPANOL B15, B30, B50, B100, B150, and B200) from BASF Corp. (Florham Park, N.J.). Still other exemplary homopolymers are commercially available from United Chemical Products (UCP) of St. Petersburg, Russia, e.g. under the trade designations SDG, JHY, and EFROLEN. These homopolymers typically do not have reactive double bonds. Other suitable polyisobutylene homopolymers are commercially available under the trade designation GLISSOPAL (e.g., GLISSOPAL 1000, 1300, and 2300) from BASF Corp. (Florham Park, N.J.). These polyisobutylene materials usually have terminal double bonds and are considered to be reactive polyisobutylene materials.

Polyisobutylene copolymers may be prepared by polymerizing isobutylene in the presence of a small amount of another monomer such as, for example, isoprene, styrene, butene, or butadiene. These copolymers are typically prepared from a monomer mixture that includes at least 70 weight percent, at least 75 weight percent, at least 80 weight percent, at least 85 weight percent, at least 90 weight percent, or at least 95 weight percent isobutylene based on the weight of monomers in the monomer mixture. Suitable isobutylene/isoprene copolymers are commercially available under the trade designation EXXON BUTYL (e.g., EXXON BUTYL 065, 068, and 268) from Exxon Mobil Corp. Other exemplary isobutylene/isoprene copolymers are commercially available from United Chemical Products (St. Petersburg, Russia) such as BK-1675N. Still other exemplary isobutylene/isoprene copolymers are commercially available from LANXESS (Sarnia, Ontario, Canada) such as LANXESS BUTYL 301, LANXESS BUTYL 101-3, and LANXESS BUTYL 402. Suitable isobutylene/styrene block copolymers are commercially available under the trade designation SIBSTAR from Kaneka (Osaka, Japan).

In some particular embodiments, a pressure-sensitive adhesive may comprise e.g. at least 20, 40, 60, 80, 90, 95, or 98 by weight polyisobutylene. Some such pressure-sensitive adhesives may be prepared by dissolving a desired polyisobutylene homopolymer (e.g. OPPANOL B15, B100, or a blend thereof) in a suitable solvent and casting it and removing the solvent to leave behind a polyisobutylene layer that exhibits pressure-sensitive properties.

Further details of isobutylene-based materials that may be used in a pressure-sensitive adhesive of a chemical indicator (as well as details of potentially suitable porous substrates, and respirators and filter cartridges with which a chemical indicator might find use), are found in U.S. Patent Application Publication 20110094514, which is incorporated by reference herein in its entirety. Details of materials that may be suitable for use as porous substrates, indicator dyes, pressure-sensitive adhesives, and so on, for use in a chemical indicator, are also found in U.S. Patent Application Publication 20130189166, which is incorporated by reference herein in its entirety.

In some embodiments, it may be desirable that such a pressure-sensitive adhesive layer be optically transparent or optically clear. This may be particularly advantageous for an adhesive layer 151 and/or 251 (noting that a single piece of adhesive may provide both of these component) e.g. in embodiments in which the indicating zone and the reference zone of patterned chemical indicator are to be interrogated (e.g. visually inspected) through these adhesive layers.

In some embodiments, the adhesive layer may be a transfer tape. The term “transfer tape” as used herein refers to a double-sided adhesive tape that has adhesive on both exposed surfaces. In some transfer tapes (e.g. as in the exemplary embodiment of FIG. 1), the exposed surfaces are simply the two adhesive surfaces of a single adhesive layer. Other transfer tapes are multilayer transfer tapes with at least two adhesive layers that may be the same or different, and in some instances intervening layers that mayor may not be adhesive layers. For example, a multi-layer transfer tape may be a 3 layer construction with an adhesive layer, a film layer and another adhesive layer. The film layer can provide handling and/or tear strength or other desirable properties, e.g. gas-barrier properties.

A variety of methods can be used to prepare the chemical indicators of this disclosure. For example, an inert, porous substrate can be provided. This inert, porous substrate can be purchased or prepared by the methods described above. In some embodiments the inert, porous substrate is a polypropylene TIPS membrane as described above. This inert, porous substrate can be imbibed with a solution of an indicator dye, or mixture of dyes, dissolved in a solvent or solvent mixture. Any suitable solvent can be used, particularly suitable ones include: alcohols such as methanol, ethanol, isopropanol and the like; ketones such as acetone and methyl ethyl ketone; esters such as ethyl acetate; ethers such as ethyl ether and tetrahydrofuran; and halocarbons such as dichloromethane. Suitable dyes to prepare acid gas indicators include, for example, Bromothymol Blue, Methyl Red, and Phenol Red, and Bromocresol Green. An aqueous base, such as sodium hydroxide or potassium hydroxide, or an aqueous acid, can be added to make the formed indicator solution basic or acidic as desired. Some such additives may provide buffering capacity (rather than e.g. merely establishing an initial pH), as noted previously. After imbibing the dye solution into the interior of the porous substrate, the porous substrate may be dried to remove the solvent (or other carrier liquid). This drying can be done at room temperature or at elevated temperature by using, for example, an oven. (It will be appreciated that indicating dyes such as those disclosed herein will typically retain or imbibe enough water of hydration during the use of the patterned chemical indicator to enable the dye to function even in the absence of a bulk water phase.)

To the inert, porous substrate e.g. with the indicator dye imbibed into it, may be laminated one or more layers of adhesive, e.g. pressure-sensitive adhesive. At least one such layer may be laminated to a first major surface of the substrate, and at least one such layer may be laminated to a second, opposing major surface of the substrate, in what will become the reference zone of the chemical indicator. The second such layer may additionally serve to secure the reference zone to a carrier, as noted earlier herein. In addition, an adhesive layer may be laminated to a major surface of the substrate in which will become the indicating zone of the indicator, for purposes of securing the indicating zone to a carrier, also as noted earlier herein. A major surface of the indicating zone, and/or at least one minor edge of the indicating zone, will remain unoccluded (e.g., exposed) rather than having any occluding layer laminated thereto or any non-porous dam disposed therein.

At least one non-porous dam will be disposed into the inert, porous substrate to provide at least one reference zone. Any appropriate treatment or process may be used for this purpose. The providing of such a dam or dams may be carried out before or after any or all of the above-mentioned adhesive layers and/or occluding layers are applied to the major surfaces of the porous substrate. The imbibing of an indicator dye solution into the reference zone of the porous substrate, if done through a major surface of the porous substrate, should be done before the major surface of the porous substrate of the reference zone are covered with an occluding layer. In many embodiments, the imbibing of the indicator dye solution (in both the reference zone and the indicating zone) may be carried out before any occluding and/or adhesive layer is laminated to a major surface thereof, e.g. to ensure that any solvent that may be present in the indicator dye solution does not attack or compromise the properties of layer.

The thus-formed patterned chemical indicator may then be installed e.g. into a filter cartridge of a respirator mask, in any convenient way, e.g. to provide an arrangement as disclosed below.

A patterned chemical indicator as disclosed herein may be used to detect, or monitor the possible presence of, any desired gaseous chemical. The term gaseous chemical broadly encompasses any substance that is present in gaseous or vapor form. In many embodiments, a gaseous chemical may be reactive gas, e.g. an acid gas and/or a basic gas. As used herein, the term “acid gas” refers to a gas that contains some acidic component. The acidic component may itself be a gas, such as, for example hydrogen chloride gas, but the acidic component need not itself be a gas, but may merely be present in the gas or gas mixture. Additionally, acid gases may not themselves be acids but acids may result from combination with other materials present in the atmosphere. It will be understood that some such materials may be neutral when in the gas phase and may only form an acid e.g. when combined with sufficient water. Exemplary acid gases that it might be desirable to monitor include e.g. SO₂, Cl₂, HCl, ClO₂, HCN, HF, H₂S, and oxides of nitrogen.

As used herein, the term “basic gases” refers to gases that contain some basic component. The basic component may itself be a gas, such as, for example ammonia, but the basic component need not itself be a gas, but may merely be present in the gas or gas mixture. Additionally, basic gases may not themselves be bases but bases may result from combination with other materials present in the atmosphere. It will be understood that some such materials may be neutral when in the gas phase and may only form a base e.g. when combined with sufficient water. Exemplary basic gases that it might be desirable to monitor include e.g. ammonia, ammonia derivatives, and amines, e.g. methylamine.

A patterned chemical indicator as disclosed herein may also find use for monitoring or detecting any of a variety of reactive gases that are not necessarily acid gases or basic gases. Such gases might include e.g. cyanogen chloride and formaldehyde.

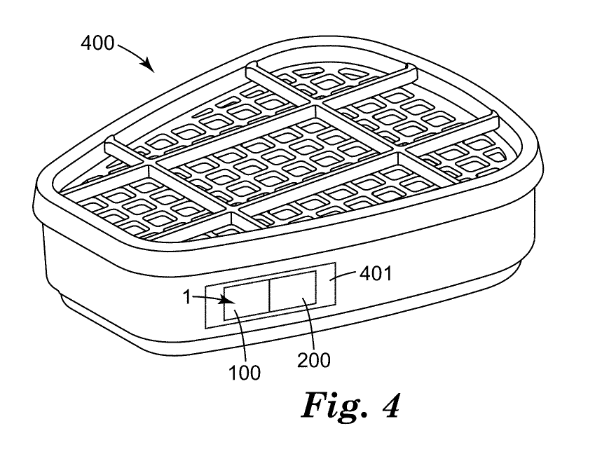

In various embodiments, a patterned chemical indicator 1 as disclosed herein may be used in a respiratory protection device of any suitable type, e.g. a personal respiratory protection device. In some embodiments, a patterned chemical indicator 1 as disclosed herein may be used as a so-called end-of-service-life indicator (ESLI) in any desired respiratory protection device. In some exemplary embodiments, a respiratory protection device with which indicator 1 is used may comprise a mask and one or more filter cartridges 400 (as shown in exemplary embodiment in FIG. 4) that is attachable to the mask and that can filter components (e.g. gaseous chemicals, particulates and so on) from air that passes through the filter cartridge. Such a filter cartridge can contain any desired material or materials (e.g. activated carbon, a non-woven filter web such as e.g. a charged electret web) for filtering any desired gaseous chemical (whether alone, or in addition to filtering other materials such as airborne particulates and the like). In some embodiments, such a filter cartridge may comprise a wall (e.g. a molded sidewall) that comprises a transparent window 401 through which a patterned chemical indicator 1 is visible. (In such a case, the transparent window 401 may serve as the aforementioned carrier 3 to which the patterned chemical indicator 1 is secured). The at least one indicating zone 100 and the at least one reference zone 200 of the patterned chemical indicator can be inspected through the window as necessary. In some embodiments this may take the form of visual inspection by a person; however, these zones could be scanned by an optical sensor if desired. In general, the herein-disclosed patterned chemical indicator 1 may be used in any circumstance in which it is desired to monitor a gaseous environment (whether e.g. a flowing airstream, an ambient indoor or outdoor environment, etc.) for the presence of a gaseous chemical such as e.g. acid gases or basic gases.

### List of Exemplary Embodiments

Embodiment 1 is a patterned chemical indicator comprising: at least one indicating zone comprising: an inert, porous substrate, and, at least one indicator dye contained within at least some of the pores of an indicating area of the inert, porous substrate of the indicating zone, wherein the inert, porous substrate of the indicating zone comprises at least one major surface that is a non-occluded surface, and/or comprises at least one minor edge that is a non-occluded minor edge; and, at least one reference zone comprising; an inert, porous substrate, and, at least one indicator dye contained within at least some of the pores of a reference area of the inert, porous substrate of the reference zone, wherein the inert, porous substrate of the reference zone comprises a first major surface that is an occluded surface and a second, oppositely-facing major surface that is also an occluded surface; and wherein the reference area of the inert, porous substrate of the reference zone is circumferentially bounded by at least one non-porous dam that extends through the thickness of the inert porous substrate from the first major surface to the second major surface and that prevents permeation of gases in an in-plane direction through the inert, porous substrate.

Embodiment 2 is the patterned chemical indicator of embodiment 1 wherein the patterned chemical indicator comprises a single inert, porous substrate bearing the at least one indicating zone and the at least one reference zone.

Embodiment 3 is the patterned chemical indicator of embodiment 2 wherein the at least one indicating zone and the at least one reference zone are spaced apart from each other along the in-plane direction of the single, inert porous substrate and wherein the at least one indicating zone and the at least one reference zone are separated from each other along the in-plane direction of the single, inert porous substrate, by a portion of the at least one non-porous dam.

Embodiment 4 is the patterned chemical indicator of any of embodiments 1-3 wherein the at least one indicator dye that is present in the reference zone is of the same composition as the at least one indicator dye that is present in the indicating zone.

Embodiment 5 is the patterned chemical indicator of any of embodiments 1-4 wherein the first major occluded surface of the inert, porous substrate of the reference zone is occluded by a first layer of impermeable organic polymeric material.

Embodiment 6 is the patterned chemical indicator of embodiment 5 wherein the first layer of impermeable organic polymeric material is a first pressure-sensitive adhesive that is adhesively bonded to the first major surface of the inert, porous substrate of the reference zone.

Embodiment 7 is the patterned chemical indicator of embodiment 6 wherein the first pressure-sensitive adhesive comprises at least 90% by weight of polyisobutylene.

Embodiment 8 is the patterned chemical indicator of any of embodiments 6-7 wherein the second major occluded surface of the inert, porous substrate of the reference zone is occluded by a second layer of impermeable organic polymeric material, which second layer of impermeable organic polymeric adhesive is a second pressure-sensitive adhesive that is adhesively bonded to the second major surface of the insert, porous substrate of the reference zone and that is of the same composition as the first pressure-sensitive adhesive.

Embodiment 9 is the patterned chemical indicator of any of embodiments 1-8 wherein the non-porous dam that circumferentially bounds the reference area of the inert, porous substrate of the reference zone comprises a predetermined region of the inert, porous substrate in which the inert, porous substrate has been densified to render it non-porous in that region.

Embodiment 10 is the patterned chemical indicator of embodiment 9 wherein the densified, non-porous region is a heat-densified region.

Embodiment 11 is the patterned chemical indicator of embodiment 9 wherein the densified, non-porous region is a solvent-densified region.

Embodiment 12 is the patterned chemical indicator of embodiment 8 wherein the non-porous dam that circumferentially bounds the reference area of the inert, porous substrate of the reference zone comprises a predetermined region of the inert, porous substrate in which a non-porous material is disposed in the pores of the inert, porous substrate to fill the pores of the inert, porous substrate to render the substrate non-porous in that region.

Embodiment 13 is the patterned chemical indicator of embodiment 12 wherein the non-porous material is chosen from the group consisting of wax, oil, and grease.

Embodiment 14 is the patterned chemical indicator of embodiment 12 wherein the non-porous material is a hot-melt adhesive.

Embodiment 15 is the patterned chemical indicator of any of embodiments 1-14 wherein the patterned chemical indicator is configured to detect the presence of acidic or basic gaseous materials and wherein the indicator dye is an acid-base dye.

Embodiment 16 is a filter cartridge comprising the patterned chemical indicator of any of embodiments 1-15, wherein the patterned chemical indicator is installed within an interior of the filter cartridge and is interrogatable through a transparent window in a wall of the filter cartridge.

Embodiment 17 is the filter cartridge of embodiment 16 wherein the patterned chemical indicator is secured to the transparent window of the wall of the filter cartridge by a sheet of double-faced pressure-sensitive adhesive, a portion of which sheet of adhesive serves to secure the indicating zone to the transparent window and another portion of which sheet of adhesive serves to secure the reference zone to the transparent window and also serves as an occluding layer to provide that the second, opposing major surface of the inert, porous substrate of the reference zone is an occluded surface.

Embodiment 18 is a personal respiratory protection device comprising a filter cartridge comprising the patterned chemical indicator of any of embodiments 1-15.

Embodiment 19 is a method of filtering breathing air using a personal respiratory protection device, the personal respiratory protection device comprising a filter cartridge comprising the patterned chemical indicator of any of embodiments 1-15.

Embodiment 20 is a patterned chemical indicator comprising: at least one indicating zone comprising: an inert, porous substrate, and, at least one indicator dye contained within at least some of the pores of an indicating area of the inert, porous substrate of the indicating zone, wherein the inert, porous substrate of the indicating zone comprises at least one major surface that is a non-occluded surface, and/or comprises at least one minor edge that is a non-occluded minor edge; and, at least one reference zone comprising; an inert, porous substrate, and, at least one indicator dye contained within at least some of the pores of a reference area of the inert, porous substrate of the reference zone, wherein the inert, porous substrate of the reference zone comprises a first major surface that is an occluded surface and a second, oppositely-facing major surface that is also an occluded surface; wherein the at least one indicating zone and the at least one reference zone are spaced apart from each other along an in-plane direction of the single, inert porous substrate and wherein the at least one indicating zone and the at least one reference zone are separated from each other along the in-plane direction of the single, inert porous substrate, by a portion of at least one non-porous dam, which porous dam extends through the thickness of the inert porous substrate from the first major surface to the second major surface and prevents permeation of gases in an in-plane direction through the inert, porous substrate.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document that is incorporated by reference herein but to which no priority is claimed, this specification as written will control.

What is claimed is:

1. A patterned chemical indicator comprising:
at least one indicating zone comprising:
an inert, porous substrate, and,
at least one indicator dye contained within at least some of the pores of an indicating area of the inert, porous substrate of the indicating zone,
wherein the inert, porous substrate of the indicating zone comprises at least one major surface that is a non-occluded surface, and/or comprises at least one minor edge that is a non-occluded minor edge;
and,
at least one reference zone comprising;
an inert, porous substrate, and,
at least one indicator dye contained within at least some of the pores of a reference area of the inert, porous substrate of the reference zone,
wherein the inert, porous substrate of the reference zone comprises a first major surface that is an occluded surface and a second, oppositely-facing major surface that is also an occluded surface;
and wherein the reference area of the inert, porous substrate of the reference zone is circumferentially bounded by at least one non-porous dam that extends through the thickness of the inert porous substrate from the first major surface to the second major surface and that prevents permeation of gases in an in-plane direction through the inert, porous substrate.

2. The patterned chemical indicator of claim 1 wherein the patterned chemical indicator comprises a single inert, porous substrate bearing the at least one indicating zone and the at least one reference zone.

3. The patterned chemical indicator of claim 2 wherein the at least one indicating zone and the at least one reference zone are spaced apart from each other along the in-plane direction of the single, inert porous substrate and wherein the at least one indicating zone and the at least one reference zone are separated from each other along the in-plane direction of the single, inert porous substrate, by a portion of the at least one non-porous dam.

4. The patterned chemical indicator of claim 1 wherein the at least one indicator dye that is present in the reference zone is of the same composition as the at least one indicator dye that is present in the indicating zone.

5. The patterned chemical indicator of claim 1 wherein the first major occluded surface of the inert, porous substrate of the reference zone is occluded by a first layer of impermeable organic polymeric material.

6. The patterned chemical indicator of claim 5 wherein the first layer of impermeable organic polymeric material is a first pressure-sensitive adhesive that is adhesively bonded to the first major surface of the inert, porous substrate of the reference zone.

7. The patterned chemical indicator of claim 6 wherein the first pressure-sensitive adhesive comprises at least 90% by weight of polyisobutylene.

8. The patterned chemical indicator of claim 6 wherein the second major occluded surface of the inert, porous substrate of the reference zone is occluded by a second layer of impermeable organic polymeric material, which second layer of impermeable organic polymeric adhesive is a second pressure-sensitive adhesive that is adhesively bonded to the second major surface of the insert, porous substrate of the reference zone and that is of the same composition as the first pressure-sensitive adhesive.

9. The patterned chemical indicator of claim 1 wherein the non-porous dam that circumferentially bounds the reference area of the inert, porous substrate of the reference zone comprises a predetermined region of the inert, porous substrate in which the inert, porous substrate has been densified to render it non-porous in that region.

10. The patterned chemical indicator of claim 9 wherein the densified, non-porous region is a heat-densified region.

11. The patterned chemical indicator of claim 9 wherein the densified, non-porous region is a solvent-densified region.

12. The patterned chemical indicator of claim 8 wherein the non-porous dam that circumferentially bounds the reference area of the inert, porous substrate of the reference zone comprises a predetermined region of the inert, porous substrate in which a non-porous material is disposed in the pores of the inert, porous substrate to fill the pores of the inert, porous substrate to render the substrate non-porous in that region.

13. The patterned chemical indicator of claim 12 wherein the non-porous material is chosen from the group consisting of wax, oil, and grease.

14. The patterned chemical indicator of claim 12 wherein the non-porous material is a hot-melt adhesive.

15. The patterned chemical indicator of claim 1 wherein the patterned chemical indicator is configured to detect the presence of acidic or basic gaseous materials and wherein the indicator dye is an acid-base dye.

16. A filter cartridge comprising the patterned chemical indicator of claim 1, wherein the patterned chemical indicator is installed within an interior of the filter cartridge and is interrogatable through a transparent window in a wall of the filter cartridge.

17. The filter cartridge of claim 16 wherein the patterned chemical indicator is secured to the transparent window of the wall of the filter cartridge by a sheet of double-faced pressure-sensitive adhesive, a portion of which sheet of adhesive serves to secure the indicating zone to the transparent window and another portion of which sheet of adhesive serves to secure the reference zone to the transparent window and also serves as an occluding layer to provide that the second, opposing major surface of the inert, porous substrate of the reference zone is an occluded surface.

18. A personal respiratory protection device comprising the filter cartridge of claim 16.

19. A method of filtering breathing air using a personal respiratory protection device, the personal respiratory protection device comprising a filter cartridge of claim 16.
